(19) United States
(12) Patent Application Publication
(10) Pub. No.: US 2002/0078445 A1
(43) Pub. Date: Jun. 20, 2002

(54) Internet appliance for interactive audio/video display using a remote control unit for user input

(76) Inventors: Imran Sharif, Milpitas, CA (US); John Bremsteller, Carrollton, TX (US); Shabbir Syed Husain, Dhaka (BD); Glen Edward Ivey, Ft. Bragg, CA (US)

Correspondence Address: ROBERT BUCKLEY, PATENT ATTORNEY, P.O. BOX 2520, MENLO PARK, CA, 94026-2520, US

(21) Appl. No.: 09/903,326

(22) Filed: Jul. 11, 2001

Related U.S. Application Data
(60) Provisional application No. 60/217,626, filed on Jul. 11, 2000.

(51) Int. Cl. G06F 3/00

(52) U.S. Cl. 725/37

(57) ABSTRACT

A network access device uses a standard video display to show functional choices and network content received from the Internet to a user. The user directs the functional operation of the network access device with a simple reduced keyset remote control unit having a relatively small number of keys similar to a consumer remote control used for television receivers and video recorders. The control choices are displayed to the user in a unique format with elements associated to characters corresponding to the same characters in the reduced keyset. The display format uses several display areas, some of which can be designated as input focus areas, any one of which can be active at a given time. The device affords low cost ready access to the informational capabilities of the Internet for users at all skill levels by eliminating a full text keyboard and a mouse.

### CLAIM FOR PRIORITY

Priority is hereby claimed for commonly-assigned Provisional Patent Application Serial No. 60/217,626 filed Jul. 11, 2000 for “Internet Appliance For Interactive Audio/Video Display Using A Remote Control Unit For User Input”.

### FIELD OF THE INVENTION

This invention relates to an internet appliance for enabling user access to the Internet. More particularly, this invention relates to an internet appliance which can be coupled to a standard video display and which interacts with a reduced keyset user interface device, such as a consumer type remote control unit of the type used with television sets and video recorders, for all user-controlled interface functions.

### BACKGROUND OF THE INVENTION

The most prevalent, and virtually the only practical way for a user to access the Internet today, is through a personal computer (hereinafter PC) having a full text keyboard and a video monitor. Other devices to access the Internet are becoming available, such as the system marketed under the name “WebTV” by Microsoft Corporation and the system marketed under the name “Iopener” by Netpliance Corporation, but these devices are essentially “low end versions” of a PC, which still employ a full keyboard and some type of video monitor, usually a consumer television set. Many PC users do not take advantage of all the benefits of a PC, including many of its Internet capabilities, due to a variety of reasons. For example, a skilled PC user is capable of manipulating the PC to send and receive audio clips and video clips via the Internet with relative ease. Many relatively unskilled PC users, however, do not use these capabilities for a number of reasons, such as an unwillingness to devote the necessary time to the amount of training required to fully utilize the full internet capabilities of a PC, the unreliability of performance of a PC with respect to such functions, and other reasons. As a consequence, many PC users do not fully enjoy the interactive information opportunities available from the combination of a PC and the Internet.

Many business organizations routinely provide PCs to employees for use in connection with their regular work duties. Although most available PCs have built-in Internet functional capabilities, including advanced and relatively sophisticated audio and video capabilities, many business applications of PCs do not require such advanced audio and video capabilities. For businesses with large work forces, providing PCs with such sophisticated capabilities for such limited business applications is cost ineffective. In addition, in many instances it may be undesirable from an employer's standpoint to provide such advanced capabilities on employees' PCs, which can lead easily to non-work related use of the employee's PC and non-productive time. On the other hand, an employee-user who is expected to fully utilize the Internet access and multimedia capabilities of a PC in the work environment, as well as individuals who have a PC for personal use only, may not need the other standard PC functions, such as word processing, spread sheets, and other specialized application programs. Consequently, the owner of the PC is paying for capabilities which are unnecessary. Further, a PC per se entails a relatively high personal cost of ownership in that a PC can be difficult to learn, configure, maintain, and upgrade. Accordingly, the need exists for a low cost and easy to use device for enabling access to the Internet for persons of all skill levels.

### SUMMARY OF THE INVENTION

The present invention is directed to an internet appliance which does not require a PC for accessing the Internet and which is relatively inexpensive to manufacture and maintain, easy to learn to use, and compatible with a large number of user network applications. A principal object of the present invention is to provide a non-PC Internet access device, or “Internet appliance”, that is highly reliable, requires low manufacturing and maintenance cost, and minimum training for users at all skill levels. Additional features and advantages of the invention will be set forth in the descriptions that follow and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the invention provides a network access device including a network connection section for communication with a network; a video section including a video signal output connectable to a video display for outputting video signals to be displayed on the video display; a user interface signal receiver for receiving user interface signals generated by a reduced keyset user interface device, and a processing unit connected to the above components, wherein the processing unit provides user interface functions by generating video signals for displaying information to the user and processing the user interface signals received by the user interface signal receiver from the user in response to the information displayed to the user, whereby the interface functions enable the user to control the network access device and navigate the display contents solely through the reduced keyset user interface device. The reduced keyset user interface device may be a remote control unit of the type normally used for controlling the functions of a conventional television set or video recorder with a small number of keys and capable of generating infrared control signals recognizable by the network access device, or a keyboard device incorporated in a housing for the network access device similar to the keyset found in wireless communication units (such as a cell phone). The video display may comprise a standard consumer television receiver, or a display of the type normally used in wireless consumer devices (such as a cell phone display).

In another aspect, the present invention provides a method for providing a user interface between an information processing system and a user, the method including the steps of using a display screen for displaying information to the user, providing a reduced keyset user device for generating control signals, and using a reduced keyset user interface device for receiving keystroke signals from the user and converting these control signals to signals compatible with the information processing system. The method employs one or more of the following features to facilitate full user interface using the reduced keyset user interface device. One feature includes displaying information to the user on the display screen, the displayed information including user interface elements, dividing the display screen into a plurality of display areas each containing displayed information, designating one of the plurality of display areas as an input focus area in response to first keystroke signals received from the reduced keyset user interface device, and interpreting keystroke signals received from the user interface device based on displayed user interface elements in the input focus area only.

Another feature includes displaying information to the user on the display screen, the displayed information including user interface elements, displaying an association of each of at least some of the user interface elements with a character (such as a numeral), and interpreting character keystroke signals received from the user interface device according to the displayed association of user interface elements with characters.

Yet another feature is used in an information processing system having a plurality of user selectable modes. Depending on the selected mode of the information processing system, the user interface displays a characteristic screen display associated with the selected mode, the characteristic screen display including layout of the display screen, selection of operations, and an associated set of commands. The interface also displays mode selection user interface elements for enabling the user to select one of the modes of the system using the reduced keyset user interface device, the mode selection user interface elements being displayed regardless of the selected mode of the information processing system.

The invention affords several advantages not found in known Internet appliances. With the emergence of powerful server based software, an Internet appliance becomes a very attractive solution for a preset task in a business environment. Many industry users or professional consumers (prosumers) that belong to large vertical businesses often perform a single task or a series of specific tasks. These tasks can be performed more effectively with an appliance that executes a web-based enterprise application. Similarly, relatively unskilled users of the invention can easily learn the simple keystrokes necessary to enjoy a large amount of the full interactional information capacity resident in the Internet.

For a fuller understanding of the nature and advantages of the invention, reference should be made to the ensuing detailed description, taken in conjunction with the accompanying drawings.

### BRIEF DESCRIPTION OF THE DRAWINGS

FIG. 1(a) schematically illustrates an Internet appliance according to an embodiment of the present invention.

FIG. 1(b) schematically illustrates an Internet appliance having additional input/output features

FIGS. 2(a)-2(c) show several application specific Internet appliance systems according to embodiments of the present invention;

FIG. 3 illustrates a network connection topology for an Internet appliance using a modem;

FIG. 4 illustrates the key surface of a consumer type remote control unit (RCU) useful as a user interface device for an Internet appliance;

FIGS. 5(a)-5(f) illustrate features of a user interface (UI) for an Internet appliance according to an embodiment of the present invention.

FIG. 5(a) shows a display layout of a UI screen.

FIG. 5(b) illustrates a highlighted input focus area.

FIG. 5(c) illustrates the technique of associating user interface elements with character keys.

FIG. 5(d) shows a display layout having scroll bars and a pop-up menu.

FIG. 5(e) shows a display layout in which the primary display area is divided into sub-areas.

FIG. 5(f) is a display layout with an area provided for displaying commercial messages.

### DESCRIPTION OF THE PREFERRED EMBODIMENTS

The term “Internet access device” typically refers to devices that have limited computing and storage capabilities and are typically connected to a network such as the Internet to utilize the capabilities of other more powerful devices on the network. An “Internet appliance” (IA) according to embodiments of the present invention is a device that is capable of providing the full functionalities of an Internet access device but has a compact structure and a simple user input device having a simple keypad with a limited set of numeric and function keys. Thus, although most functions performed by the invention can be performed by a PC, other types of Internet access devices or a system of a plurality of networked devices, the essence of the invention lies in its simple and compact structure, and its ability to provide a complete user interface using a much more simple user input device than the text entry keyboard and mouse required for a PC. In particular, a network access device that works with a reduced keyset user interface device with a minimum set of keys for user interface provides simplicity of operation and over-all ease of use.

Internet appliances are typically task oriented devices designed to perform a limited set of functions directly relevant to the user. One example of an Internet appliance is a device optimized for use as a companion to a digital still camera (DSC). This Internet appliance may access a remote server where digital images taken with the DSC are stored (in addition to or instead of storing digital images locally), and displays the images on a TV set connected to the Internet appliance at the user's location. Another example is a fax compatible Internet appliance having a modem system and capable of communicating using both data (computer) modem protocols and standard fax protocols. Yet another example is a web browser application having browsing, e-mail, chat and other capabilities.

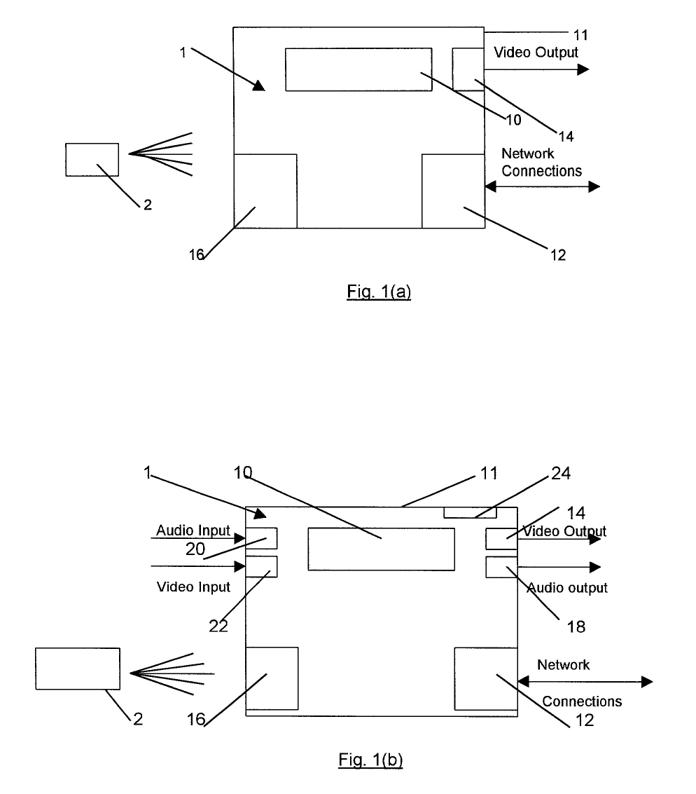

Referring to FIG. 1(a), an Internet appliance 1 according to an embodiment of the present invention comprises a small device that includes a processing unit 10; a wired or wireless network connection section 12 such as a modem for communication with a network; a video section 14 including a video signal output, such as a television interface for outputting video and audio signals, or separate video and audio signal outputs; and a user interface signal receiver 16 for receiving user interface signals from a reduced keyset user interface device 2, such as a consumer type remote control unit (hereinafter RCU). The RCU used in the preferred embodiment of the invention is illustrated in part in FIG. 4. The above components are incorporated into a housing 11 to form an integral unit. The processing unit 10 is connected to the network connection section 12, the video signal output 14 and user interface signal receiver 16 and controls all aspects of the Internet appliance functions.

The reduced keyset user interface device 2 is a device that has a small number of keys and transmits a small number of keystroke signals associated with the keys. As used in this specification, the term “reduced keyset user interface device” excludes any device that has a full text entry keyboard. The video signal output 14 can be connected to a discrete display such as a television receiver, a monitor, or a digital display (such as a liquid crystal display) for displaying information, so that the Internet appliance unit need not have its own video display in the interest of reducing the device size and cost.

The user interface signal receiver 16 is the only device for receiving user interface information from the user (via the reduced keyset user interface device 2), and the Internet appliance unit does not require its own keyboard input device with text entry keys. The lack of an integral video display device and a keyboard allows the Internet appliance to have a compact structure and relatively low cost. User interface is provided solely through the cooperation with the ancillary video display and the reduced keyset user interface device 2.

The unique characteristics of the Internet appliance are its compact structure, low cost, and the ability to provide full user interface using a reduced keyset user interface device such as a consumer type RCU. Thus, the system configuration contained in the housing 11 shown in FIG. 1(a) constitutes the basic Internet appliance. Additional features may be added to this basic Internet appliance, so long they do not compromise the characteristics of the Internet appliance.

As shown in FIG. 1(b), several features may be added to most Internet appliances, although not required, including: an audio output 18, an audio input 20, a video input 22, and visual indicators 24. These features may be actual input and output devices such as a speaker, a microphone, and a video camera that are housed in the housing 11, provided that they can be made sufficiently compact. Alternatively, they may comprise input and output signal terminals provided on the housing 11 for connecting with external devices such as speakers, microphones and video cameras. The audio and video input may be used to capture and store voice and image information from the user. The audio output 16 may be used to produce a user feedback sound such as a beep or click each time the signal resulting from a user key actuation on the user interface device 2 is received and processed. If a key press is received but ignored because it is currently invalid, the user interface may remain silent or make a different (error) sound. The visual indicators 24, which may be mounted on an LED panel, are typically provided on the housing 11 for providing the user with visual indications of system statuses.

In addition to the above features that are preferably provided for most Internet appliances, other types of data or signal interfaces may be added to application specific Internet appliances to meet their specific application requirements. Such application specific Internet appliances retain the basic characteristics of an Internet appliance, such as compactness in size and cost, and the use of a reduced keyset user interface device for the user interface.

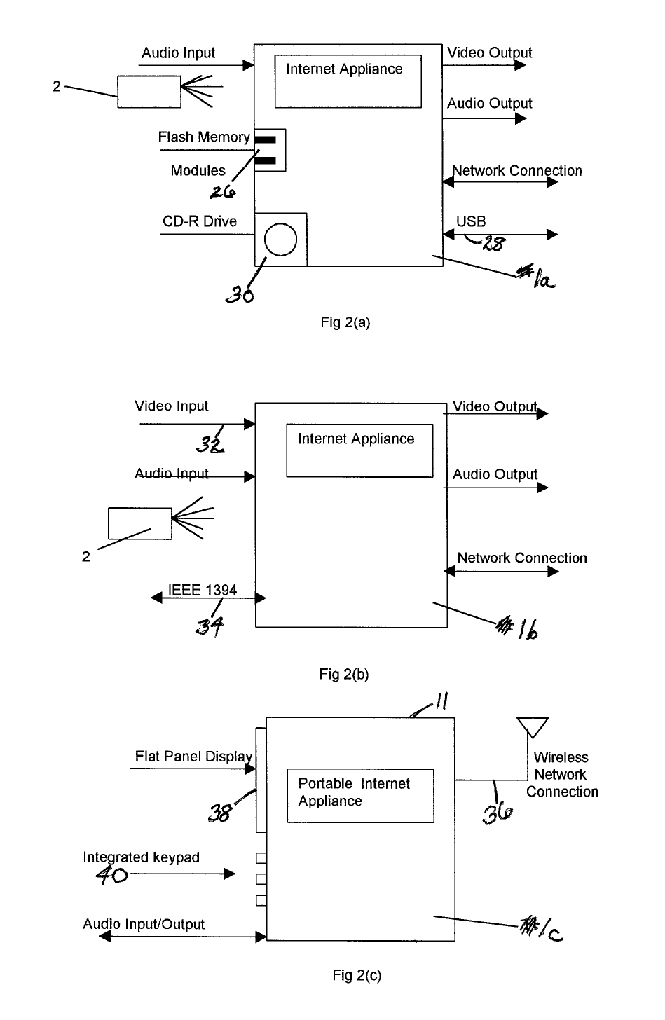

FIGS. 2(a)-2(c) are several examples of such application specific appliances and their applications. FIG. 2(a) shows an Internet appliance optimized for use as a companion to a digital still camera (DSC). This Internet appliance 1 a has removable flash slots 26 for accepting one or more different types of consumer flash memory cartridge modules that DSCs use for picture storage instead of film. The Internet appliance may have a Universal Serial Bus (USB) host port 28 for connecting a printer (not shown) used to make hard copy versions of electronically stored pictures or directly connecting the Internet appliance to the DSC. It may also have a recordable Compact Disc (CDR) drive 30 so that it can locally and cost effectively archive a large number of pictures for later viewing.

FIG. 2(b) shows an Internet appliance lb with both analog and digital (IEEE1394) video inputs, and an internal video compression/decompression subsystem (not shown) within the processing unit. Such an Internet appliance may be optimized for manipulation of streaming audio/video data, including transmission of (compressed) audio/video streams to the network for remote storage or receipt. The Internet appliance lb has an analog video input 32 for capturing image streams from analog video cameras and other sources. It may also have an IEEE 1394 (“firewire”) interface 34 for capturing audio and image streams from digital video cameras.

FIG. 2(c) shows a portable Internet appliance Ic with a wireless network connection 36 and a flat panel display 38. In addition, an integrated keypad 40 may be provided on the housing 11. The keypad 40 has a remote control style layout and does not include text entry keys. Such an Internet appliance may be optimized for accessing network services while traveling. For example, it may be used by a real estate agent to access listing information and directions (e.g., while out of the office with clients) or to upload listing information (e.g., while at a property to be newly listed). As will be apparent to those skilled in the art, many application specific Internet appliances similar to those shown in FIGS. 2(a)2(c) may be provided.

An Internet appliance has a network connection device and is preferably connected to a network. A networked Internet appliance may be referred to as a “client device”, and information may be processed by a multitude of servers on the Internet. The local client device has information processing capabilities, but it typically requires resources on the Internet to accomplish a large part of its functions. An Internet appliance, however, is typically able to perform certain information processing functions even when the network connection is inactive.

The term Internet appliance is not intended to be limited to devices having any particular network connection configuration, and may include devices that are stand-alone for at least a part of the time.

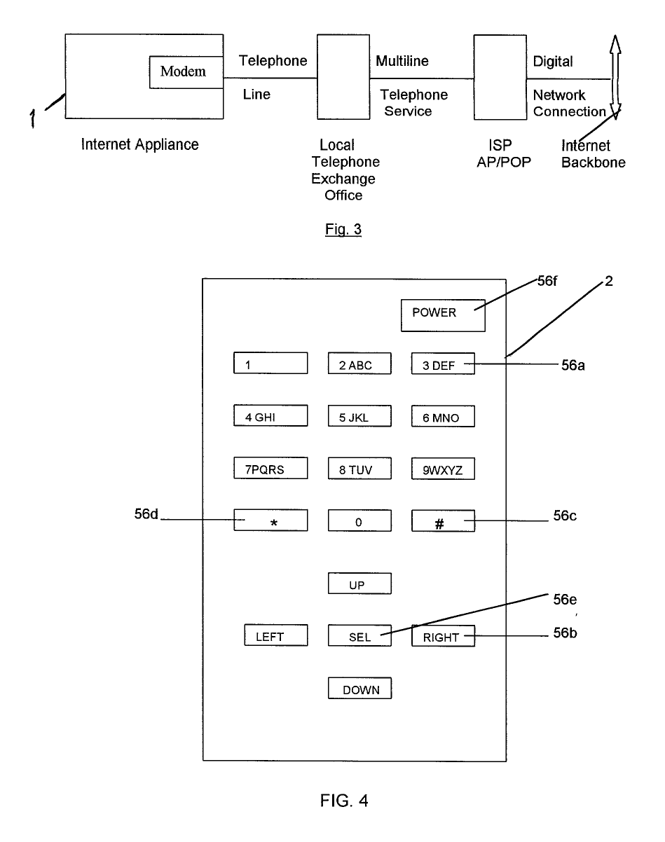

Various embodiments of the invention are typically used as a network connection to the Internet, but the invention may be used with other types of network, such as an intranet. For internet appliances that connect to the network using a modem, an Internet Service Provider (ISP) is typically employed to provide the hardware and software infrastructure that provides the link between the modem in the appliance and the other systems on the network to which it connects. FIG. 3 illustrates an Internet appliance connection topology using a modem 42. In the illustrated embodiment, the Internet appliance 1 is connected to a local telephone exchange office 46 via a telephone line 44. An ISP AP/POP (Access Point/Point of Presence) unit 50 is connected to the local telephone exchange office 46 via a multi-line telephone service 48 and to the internet backbone 54 via a digital network connection 52 such as T1, T3 or T5 lines.

An Internet appliance network connection shown in FIG. 3 using a telephone modem is suitable for appliances that interoperate with fax systems, but the category of Internet appliance devices is not limited to those employing a modem for the network connection. Any network connection technology, wired or wireless, may be employed by an Internet appliance 1. All of the individual components of the Internet appliances described above are known in the art and/or commercially available. The networking schemes and techniques are also known in the art.

The Internet appliance according to embodiments of the present invention cooperates with a reduced keyset user interface device to accomplish all user interface functions. As used in this specification, the term “reduced keyset user interface device” refers to an input device having a small number of character (alpha or numeric or both), direction (arrow) and function keys that generate a small set of keystroke signals. The term reduced keyset user interface device excludes any device that has a full text entry keyboard. In this specification, the description “a small number of keys” is understood to mean a set of ten numeric keys, a set of four direction keys, and a limited number (such as 3-5) of function keys. An example of a reduced keyset user interface device is a consumer style remote control unit (RCU). Another example is the keypad of a cellular phone. In other words, cellular phones, which may have infrared and/or radio frequency transmitters and receivers, may be used to interact with an Internet appliance according to the invention.

FIG. 4 illustrates a keyset surface of a typical reduced keyset user interface device used in the invention. As seen in FIG. 4, the keyset includes a set of ten numeric keys 56a, four arrow or direction keys (Up, Down, Left and Right) 56b, a Pound key (“#”) 56c, a Star key (“*”) 56d, a Select key 56e, and an On/Off toggle key 56f. Alternatively, the four arrow keys may be replaced by a “joybutton” type of device (i.e., an input device that has single switches in the cardinal locations instead of multi-value analog sensors). This preferred layout of 18 keys is optimized for ease of use and operation. This key set has the additional advantage that it is very similar to the keypad found on cordless telephone handsets (such as the Star and Pound keys). Of course, the keys on the user interface device, especially the function keys such as the Pound, Star and Select keys, may be labeled differently without affecting the basic function of the user interface device. In addition, more or fewer keys may be used, and auxiliary keys such as shift, control or alt keys may be provided to expand the number of available keystroke signals, as necessary. A keystroke input device satisfies the requirement of a reduced keyset user interface device according to the present invention so long as it has relatively few function keys and does not have a full set of text entry keys. Further, the reduced keyset user interface device may be a wireless or wired device, depending on the particular application. For example, a user interface device for a web browser application connected to a standard TV receiver may suitably use a wireless reduced keyset user interface device, while a portable Internet appliance such as that shown in FIG. 2c or a fax compatible Internet appliance shared by multiple users may have a reduced keyset keypad provided on the housing of the Internet appliance itself.

The processing unit 10 of the Internet appliance provides user interface functions that allow the Internet appliance to interface with the user via a reduced keyset user interface device. Specifically, the user interface functions generate output video signals for displaying information to the user, and interprets user interface signals received from the user interface device 2 in accordance with the information displayed on the video display. It is noted that although the Internet appliance 1 cooperates with the reduced keyset user interface device 2, the user interface device 2 is not considered a necessary part of the integral unit that constitutes the Internet appliance. Thus, the user interface device 2 may be acquired separately from the Internet appliance 1. While an Internet appliance 1 does not necessarily include the reduced keyset user interface device 2, the uniqueness of the Internet appliance 1 lies in its ability to interface with such a user interface device 2 to enable the user to control and navigate the system with ease. In other words, the Internet appliance 1 is capable of providing full control and navigation functions by receiving and interpreting a limited number of keystroke signals transmitted by a reduced keyset user interface device 2.

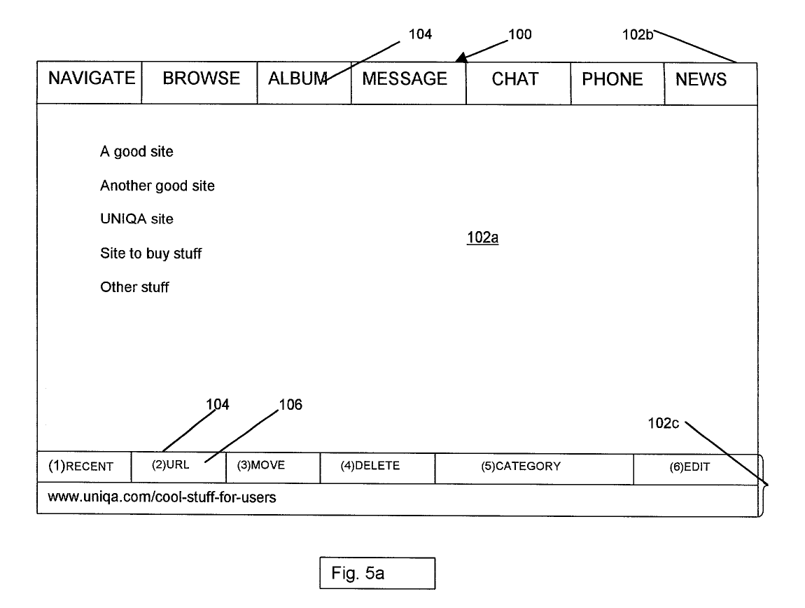

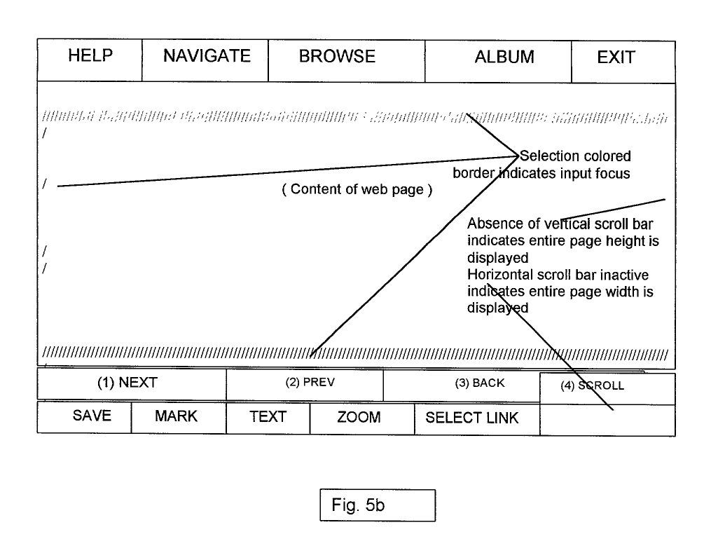

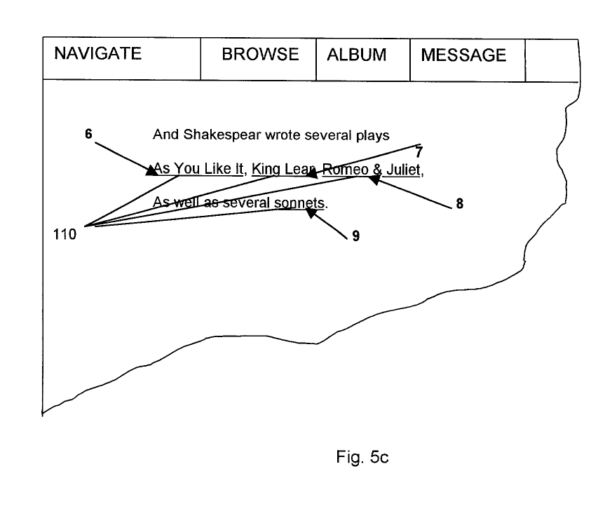

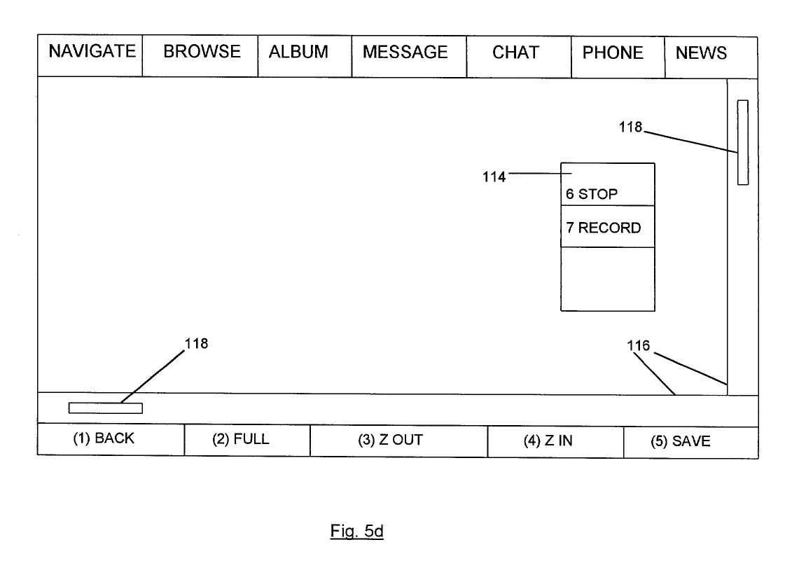

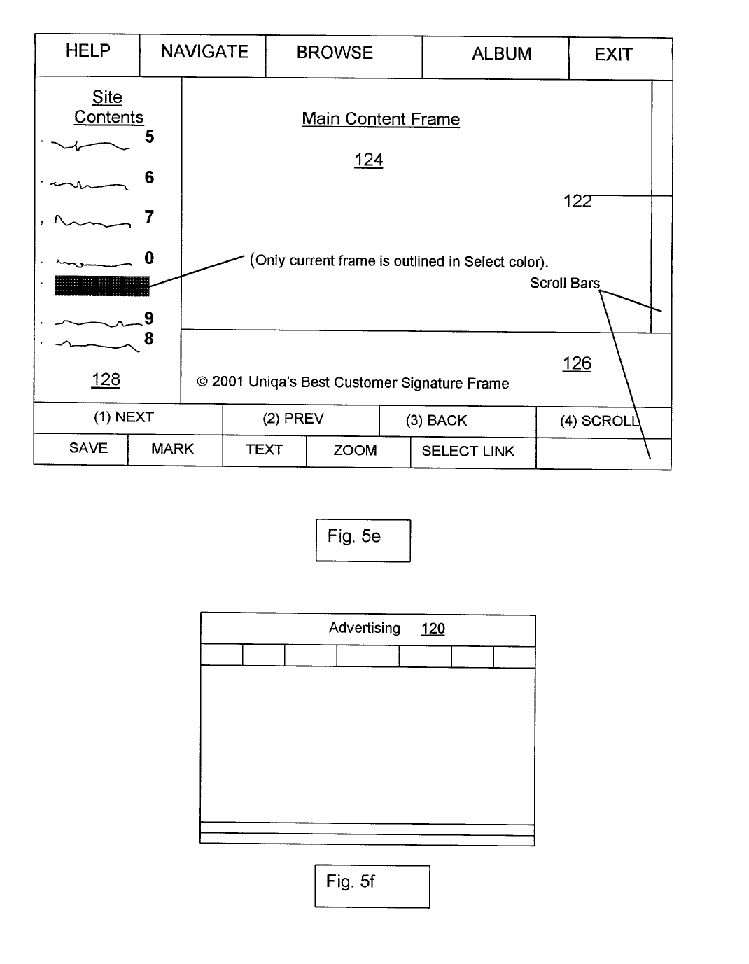

Described below is a user interface (UI) according to an embodiment of the present invention. An Internet appliance 1 implementing a web browser application is used as an example. Referring to FIG. 5(a), the video display screen 100 of the UI is divided into a plurality of regions or areas, only one of which is “active” at a given time, i.e., is functional to interpret the user input signals. For each area, the UI's basic responses to each control keystroke are preferably the same. The UI screen shown in FIG. 5(a) is divided into a primary display area 102a for displaying information, and one or more (or none) horizontal bars 102b and 102c at the top and bottom of the screen. The top and bottom areas 102b and 102c are relatively narrow and contain multiple control “button” icons 104, each button containing a text string or image that identifies an operation (such as a mode or command) currently available to the user. The top and bottom horizontal areas 102b and 102c may be referred to as “button bars”. In the embodiment of FIG. 5(a) (the web browser interface), one button bar 102b is provided at the top of the screen to provide for system mode selection, such as Navigate, Browse, etc. The contents of the top button bar 102b are preferably consistent between all of the different modes and screens of the UI. The primary display area 102a may also be used to display commands, such as commands for selecting sub modes within a mode. The bottom button bar 102c contains buttons for commands available to the user in the current mode or sub mode. The commands in the bottom button bar(s) are dynamically changed according to the currently selected mode or sub mode of the UI. In a button bar, the set of buttons and their labeling (text and/or graphics) are essentially static and are predetermined by the design and structure of the software, even though they change in response to user actions. The primary display area, on the other hand, displays content that is typically determined by data from the network and/or data supplied by the user (e.g., uploaded images). In other words, the content of button bars is typically dictated by a finite state machine, while the content and behavior of a primary display area is open and infinite.

The user uses keys on the reduced keyset user interface device 2 to navigate through the UI. At any given time, only one of the plurality of screen areas 102a-102c is active and capable of interpreting key signals. This screen area is referred to as the input focus area, or as the screen area having the “input focus”. The received keystroke signals will be interpreted according to rules associated with the input focus area only. The Pound key (“#”) on the user interface device is used to designate the input focus area by rotating the input focus among the different screen areas in a predefined order, such as from top to bottom in the example of FIG. 5(a). The Pound key sequentially rotates input focus through all of the display areas. As illustrated in FIG. 5(b), the input focus area may be highlighted by a border 108 drawn around it or by a particular background color, etc. The input focus area typically has one item being currently selected (e.g., a currently selected button for the button bars, or a currently selected data item for the central screen area). Some or all of the direction arrow keys (Up, Down, Left and Right) are used to select buttons or data items within the input focus area. For example, in FIG. 5(a), the Left and Right keys may be used to select buttons in the button bars when a button bar is the input focus area, and the Up and Down keys may be used to select items in the primary display area when that area is the input focus area. To “select” here means to cause a button or item to be selected and highlighted (e.g. having different colored text or background), without causing the associated operation to be executed. The Select key is used to invoke or execute the operation associated with the currently selected button or data item. For example, invoking a mode button when in the top (mode) button bar will change the mode of the UI, and invoking a command button when in the bottom (command) button bar will execute the command. If an operation represented by a button is currently not available, the button may be shown on the display as “grayed out”, and the Select key will have no effect on the grayed out button. Depending on user actions and asynchronous events, the set of operations the user may choose from can change dynamically, so that the state of a button may be updated at any time.

In addition to selecting and invoking the application's operations using the arrow and Select keys of the user interface device 2, the numeric keys may be used to select and/or invoke commands. This is indicated to the user by displaying a numeral 106 associated with a displayed button 104, as shown in FIG. 5(a). As illustrated in FIG. 5(c), user interface elements 110 displayed in the primary display area, such as a link in a web page, may also be designated by numerals 112 and associated with numeric keys. In this case, the association of numerals and user interface elements may be determined by information supplied in the web page, such as HTML directives. The association of numerals and user interface elements may also be determined automatically by analyzing the content of the page and the current display configuration, such as the screen locations of the user interface elements to be associated. Preferably, the association is such that each numeric key is associated with only one user interface element (including buttons) on the entire UI screen, so that the numeric key operation may be used without regard to which area has the input focus. In other words, the user is not required to change the input focus when invoking a numerically labeled item located in an area other than the input focus area. Alternatively, the numeric key association may be unique only within each screen area, in which case the numeric key operation must be used in conjunction with input focus selection. The operations associated with the numerically labeled buttons or other user interface elements (collectively referred to as user interface elements) are invoked when corresponding numeric keystroke signals are received. Alternatively, the numerically labeled user interface elements may be selected but not invoked by the numeric keystroke signals, and a subsequent Select key press. If an operation represented by a numerically labeled interface element is not available, the element may be shown on the display screen as “grayed out”, and the numeric keys will have no effect on the grayed out element. Certain other keys such as the Star key may be used in similar ways as described above to invoke user interface elements.

As mentioned above, the mode bar (e.g. the button bar 102b provided at the top of the screen in the embodiment of FIG. 5(a)) is preferably consistently displayed regardless of what mode is currently selected. This enables the user to easily select one of the modes of the system using the reduced keyset user interface device 2. Depending on the selected mode, on the other hand, the UI may display a characteristic screen display associated with the selected mode, including the general layout of the display screen, selection of operations, associated set of commands, etc. Thus, the user will be able to associate certain screen features with certain modes.

Other interface features may be provided in cooperation with the keys. For example, as shown in FIG. 5(d), the Star key on the user interface device may be used to toggle the presentation of a pop up command menu 114 or a dialog box, and the arrow and Select keys, and/or the numeric keys may then be used to select and invoke the commands or to enter responses in similar fashions as described above. The Star key may also be used as a secondary mechanism to rotate the user interface between several possible conditions. For example, as shown in FIG. 5(e), the display may be divided into a hierarchy of areas, in which one or more first level areas, such as primary display area 122 and the button bars, is divided into multiple second level areas 124, 126 and 128. The input focus is rotated between the first level areas using the Pound key. When the input focus is in a first level area 122 containing multiple second level areas 124, 126 and 128, the Star key is used to rotate the input focus between the individual second level areas within the focus first level area. Similarly, when individual controls on the display are given the input focus, the Star key can be used to rotate between multiple available data input modes for the current control.

As shown in FIG. 5(d), scroll bars 116 may be provided for a screen area, such as the primary display area. A scroll bar may be an area that can be rotated into input focus using the Pound key. Alternatively, the scroll bars may be treated as a part of the display area to be scrolled, and given input focus whenever the display area to be scrolled is in input focus. As another alternative, the scroll bars may be normally hidden (not displayed), and a command button may be provided for the user to display the scroll bars and give them input focus. When a scroll bar has input focus, the arrow keys or other function keys may then be used to move the scroll buttons 118 in order to scroll the screen area. As another alternative, additional keys may be specially provided for scrolling.

The UI may be designed to support advertising content pushed from a server to the client or downloaded from a server by the client while the client is connected to the network, as shown in FIG. 5(f). The advertising area 120 is preferably treated as one of the screen areas that can be rotated into input focus using the Pound key. The advertising area may be treated as a single-button button bar or as a primary display area. When the advertisement has input focus, user interface elements contained therein may be selected in similar ways as in other screen areas. More generally, a part of the screen can be allocated to a secondary function independent from the primary application of the appliance 1 and the commands thereof. For example, in an appliance that supports advertising but not a web browser, the advertising area may always display a single graphic file and be treated as a big monolithic button (rather than a mini HTML page, because it has no navigation within the advertising area). This may be implemented by having an “ad application” running simultaneously and in parallel with the main application that the appliance is intended to deliver to its user. Another example of such a “secondary” application is a stock ticker. Like the advertising area, this area does not support any real user input, modes or commands. Many features of the user interface described above are designed to meet the need of providing full user interface capabilities while cooperating with a reduced keyset user interface device 2 having a limited set of keys and lacking a text entry keyboard or a mouse type device. For example, dividing the display screen into screen areas and giving input focus to one screen area at a time reduces the number of user interface elements that a user has to go through when selecting an element using the arrow keys. Similarly, associating user interface elements with numeric keys enables the user to invoke an interface element using a single key press.

The UI features described above are preferably implemented in the processing unit and associated software. The programming techniques for implementing these features are generally known.

It will be apparent to those skilled in the art that various modifications and variations can be made in the user interface of the present invention without departing from the spirit or scope of the invention. For example, the UI screen can be divided into any number of screen areas, although three to four screen areas are generally preferable to avoid screen crowding and user confusion. While the examples shown in FIG. 5 use horizontal button bars at the top and bottom of the screen, other screen layouts can be employed. In addition, although specific examples of key association for the UI are described, the key association is flexible and not limited to these examples. For instance, different functions may be assigned to the Pound, Star and Select keys, or some of the numeric keys may be used as arrow keys, etc. Moreover, although the UI is described in the context of a network access device, it is not limited to such devices and may be used in any information processing device or other appliance that provides for user input via a reduced keyset type of input device. In addition, the above described UI features are not limited to applications in networked devices: they can be applied to stand alone devices that operate independently of the network or a server for extended periods. Thus, it is intended that the present invention cover modifications and variations of this invention that come within the scope of the appended claims and their equivalents.

1. A network access device comprising:
a network connection section for communication with a network;
a video section including a video signal output connectable to a video display for outputting video signals to be displayed on the video display;
a user interface signal receiver for receiving user interface signals generated by a reduced keyset user interface device; and
a processing unit connected to the network connection section, the video section and the user Interface signal receiver, wherein the processing unit provides user interface functions by outputting video signals for displaying information to the user and processing user interface signals received by the user interface signal receiver and generated by the user in response to the output video signals, the user interface functions enabling the user to control and navigate the operation of the network access device solely through the reduced keyset user interface device.

2. The network access device of claim 1, further including a housing that contains the network connection section, the video section, the user interface signal receiver, and the processing unit.

3. The network access device of claim 2, further including at least one device selected from the group consisting of an audio output device, an audio signal output, an audio input device, an audio signal input, a video input device, a video signal input, and visual indicators, the at least one device being carried by the housing and being connected to and controlled by the processing unit.

4. The network access device of claim 1, wherein the processing unit provides user interface functions by processing a set of user interface signals consisting of a set of numeric keystroke signals and a small number of functional keystroke signals.

5. The network access device of claim 1, wherein the user interface signal receiver is a wireless signal receiver.

6. The network access device of claim 1, further comprising a reduced keyset user interface device consisting of a set of numeric keys and a small number of functional keys, the reduced keyset user interface device being coupled to the user interface signal receiver.

7. A method for providing a user interface between an information processing system and a user using a display screen for displaying information to the user and a reduced keyset user interface device for transmitting keystroke signals to the information processing system, the method comprising the steps of:
displaying information to the user on the display screen, the displayed information including user interface elements;
dividing the display screen into a plurality of display areas each containing displayed information;
designating one of the plurality of display areas as an input focus area in response to first keystroke signals received from the reduced keyset user interface device; and
interpreting keystroke signals received from the reduced keyset user interface device based on displayed user interface elements in the input focus area only.

8. The method of claim 7, wherein each of the plurality of screen display areas is capable of being designated as an input focus area, and wherein the designating step sequentially designates input focus areas according to a predetermined order in response to the first keystroke signals.

9. The method of claim 7, wherein the dividing step includes dividing the display screen into one or more primary display areas for displaying dynamic text or graphics, and one or more button bars each containing one or more buttons, each button representing an operation of the information processing system.

10. A method for providing a user interface between an information processing system and a user using a display screen for displaying information to the user and a reduced keyset user interface device for transmitting keystroke signals including numeral keystroke signals to the information processing system, the method comprising the steps of:
displaying information to the user on the display screen, the displayed information including user interface elements;
displaying an association of each of at least some of the user interface elements with a characterl; and
interpreting character keystroke signals received from the reduced keyset user interface device according to the displayed association of user interface elements with characters.

11. The method of claim 10, wherein the information displayed on the display screen includes information accessed through the Internet, and at least some of the user interface elements associated with characters are links contained in a web page.

12. The method of claim 11, wherein the association of characters and user interface elements is determined by information contained in the web page.

13. The method of claim 11, wherein the association of characters and user interface elements is determined by analyzing the content of the web page and display configuration of the display screen.

14. A method for providing a user interface between an information processing system and a user using a display screen for displaying information to the user and a reduced keyset user interface device for transmitting keystroke signals to the information processing system, the information processing system having a plurality of modes selectable by the user, each mode performing predetermined functions, the method comprising the steps of:
displaying information to the user on the display screen, the displayed information including user interface elements, depending on the selected mode of the information processing system, displaying a characteristic screen display associated with the selected mode, the characteristic screen display including layout of the display screen, selection of operations, and associated set of commands; and
displaying mode selection user interface elements for enabling the user to select one of the modes of the system using the reduced keyset user interface device, the mode selection user interface elements being displayed regardless of the selected mode of the information processing system.
